(19) United States
(12) Patent Application Publication
(10) Pub. No.: US 2011/0103202 A1
(43) Pub. Date: May 5, 2011

(54) OPTICAL DISK UNIT AND REPRODUCTION METHOD THEREFOR

(75) Inventor: Norimoto ICHIKAWA, Fujisawa (JP)

(73) Assignee: HITACHI-LG DATA STORAGE, INC.

(21) Appl. No.: 12/917,992

(22) Filed: Nov. 2, 2010

(30) Foreign Application Priority Data
Nov. 4, 2009 (JP) 2009-252705

(51) Int. Cl. G11B 7/085

(52) U.S. Cl. 369/30.23; G9B/7.042

(57) ABSTRACT

It is desirable to provide a reproduction method having a high operating efficiency in an optical disk unit containing a mass storage memory such as a semiconductor memory. Data to be recorded is recorded on both an optical disk and the mass storage memory. Verify flags respectively corresponding to recording sectors or ECC blocks of an optical disk medium are stored in a control memory. In response to an instruction to reproduce the data, the data recorded on an optical disk is reproduced and verified when the data is not yet verified in reference to the verify flag. When the data has been verified, the data recorded on the mass storage memory is read and outputted to reduce response time, current consumption, and noise significantly. The mass storage memory is mounted in the optical disk unit to contribute to downsizing of a recording and reproduction device.

### INCORPORATION BY REFERENCE

This application relates to and claims priority from Japanese Patent Application No. 2009-252705 filed on Nov. 4, 2009, the entire disclosure of which is incorporated herein by reference.

### BACKGROUND OF THE INVENTION

1. Field of the Invention

The present invention relates to an optical disk unit and a method for reproducing the optical disk unit, particularly to an optical disk unit including a mass storage memory to achieve a high operating efficiency and a method for reproducing the optical disk unit.

2. Description of the Related Art

In some recording and reproduction devices using an optical disk unit, not only an optical disk but other recording mediums are used as recording mediums. One example of the mediums is a mass storage magnetic disk memory called an HDD (hard disk drive). The HDD can function as a cache memory for an optical disk and as a data storage, as well as the optical disk, for storing data for a long time. The recording capacity of the HDD may be the same as or greater than that of an optical disk.

Japanese Patent Application Laid-Open No. 2000-306048 discloses a portable information reading device for recording read information onto removable mediums without being coupled to a main body of an information processing device such as a personal computer.

Japanese Patent Application Laid-Open No. H10 (1998)-289557 discloses a method for effectively using portable external storage mediums.

### SUMMARY OF THE INVENTION

In contrast to an optical disk unit having an HDD that functions as a cache memory, an optical disk unit having an SSD (Solid State Drive), which is a mass storage semiconductor memory, instead of an HDD, as a cache memory can be considered. As semiconductor memories become inexpensive, the possibility of optical disk units having SSDs increases. The SDD is much smaller in size than the HDD and consumes much smaller current than the HDD. Therefore, by use of the SDD in a space of a conventional optical disk unit, a recording and reproduction device itself can be downsized.

By the way, many errors occur on an optical disk during recording and reproduction in comparison with other recording mediums. Therefore, verification is usually executed. The verification is operation for determining whether information has been recorded with a quality with which error correction is possible at the time of reproduction. However, no verifying method achieving a high operating efficiency has been disclosed for optical disk units containing the above described mass storage semiconductor memory because the possibility of the optical disk units has increased only recently.

In light of the above-described problem, it is desirable to provide an optical disk unit containing a mass storage memory and operating efficiently and a reproduction method for the optical disk unit.

For addressing the above problem, the present invention provides an optical disk unit for recording and reproducing information data by use of an optical disk as a first recording medium. The optical disk unit includes: a buffer memory for receiving the information data to be recorded onto the first recording medium and temporarily storing a predetermined amount of the information data, and for storing temporarily and outputting a predetermined amount of reproduced information data; a second recording medium coupled to the buffer memory to store the information data which has been stored in the buffer memory and is to be recorded onto the first recording medium; a recording circuit for receiving the information data which has been stored in the buffer memory and is to be recorded onto the first recording medium, and for adding, to the information data, an error correcting code for correcting errors occurring during recording and reproduction on the first recording medium; an optical head for receiving the information data to which the error correcting code has been added in the recording circuit to optically record and reproduce the information data onto and from the first recording medium; a reproduction circuit for receiving the information data reproduced by the optical head to detect and correct errors occurring in the information data during recording and reproduction on the first recording medium, and for providing, to the buffer memory, the information data after the errors are corrected; and a system control circuit for controlling operation of the optical disk unit to execute verification for determining whether the information data has been recorded onto the first recording medium with a quality with which error correction is possible in the reproduction circuit at the time of reproduction. In the optical disk unit, the system control circuit, when reproducing and outputting the information data from the buffer memory, outputs the information data stored in the second recording medium when the information data has been already subject to the verification, and executes the verification for and outputs the information data recorded on the first recording medium when the information data is not yet subject to the verification.

The present invention also provides a method for reproducing an optical disk unit that records and reproduces information data by use of an optical disk as a first recording medium and a semiconductor memory as a second recording medium, and stores verify flags showing whether the information data recorded on the first recording medium has been already subject to the verification for determining whether the information data has been recorded with a quality with which error correction is possible at the time of reproduction. The method includes: determining whether the information data to be reproduced has been already subject to the verification in reference to the verify flags; first outputting the information data stored in the second recording medium by reading the information data when determining that the information data has been already subject to the verification from a result of determination of the determining step in reference to the verify flags; reproducing the information data stored in the first recording medium when determining that the information data is not yet subject to the verification from a result of determination of the determining step in reference to the verify flags; verifying the information data reproduced in the reproducing step to determine whether the information data has been recorded with a quality with which error correction is possible at the time of reproduction; second outputting the information data reproduced in the reproducing step after changing the verify flag to a state showing that the information data has been already subject to the verification when determining that the information data has been recorded with a quality with which error correction is possible at the time of reproduction from a result of determination of the verifying step; recovering the information data recorded on the first recording medium on the first recording medium when determining that the information data has not been recorded with a quality with which error correction is possible at the time of reproduction from a result of determination of the verifying step; determining whether recovery in the recovering step has been successful; third outputting the information data recovered in the recovering step by reproducing the information data after changing the verify flag to a state showing that the information data has been already subject to the verification when determining that the recovery has been successful from a result of determination of the recovery determining step; and forth outputting an error flag when determining that the recovery has been failed from a result of the recovery determining step.

The present invention has an advantage that an optical disk unit containing a mass storage memory and having a high operating efficiency and a reproduction method for the optical disk unit can be provided, contributing to improvement of usability of the optical disk unit.

### BRIEF DESCRIPTION OF THE DRAWINGS

These and other features and objects and advantages of the present invention will become more apparent from the following description when taken in conjunction with the accompanying drawings wherein:

FIG. 1 is a block diagram of an optical disk unit of one embodiment of the present invention;

FIG. 2 is a conceptual diagram showing an example of verify flags in one embodiment of the present invention;

FIG. 3 is a block diagram of a recording circuit in one embodiment of the present invention;

FIG. 4A is a block diagram of a reproduction circuit in one embodiment of the present invention;

FIG. 4B is a block diagram of the reproduction circuit in one embodiment of the present invention; and

FIG. 5 is a flowchart of a reproduction method in one embodiment of the present invention.

### DETAILED DESCRIPTION OF THE EMBODIMENT

Examples of embodiments of the present invention are explained below in reference to the appended figures.

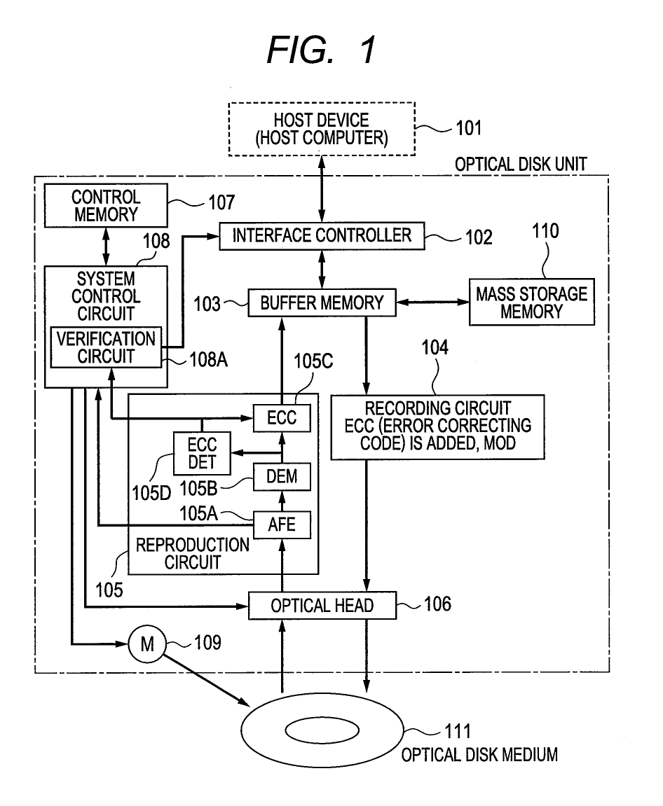

FIG. 1 is a block diagram of an optical disk unit of one embodiment of the present invention. Particularly, the optical disk unit described herein is shown within a broken line, and records and reproduces data onto and from an optical disk 111 based on control from a host device 101 including a host computer such as a PC (personal computer).

The optical disk 111, which is a recording medium, is a CD (compact disk), a DVD (digital versatile disk), a BD (Blu-ray Disk), etc. Of course, any of a Write Once Read Many medium such as a BD-R and DVD-R onto which data is able to be written only once and a rewritable disk such as a BD-RE and DVD-RAM may be applicable.

The mounted optical disk 111 is rotated by a spindle motor 109. A driving control signal for the rotation is sent from a system control circuit 108 containing, e.g., a microprocessor.

A laser beam is radiated from an optical head 106 onto a recording surface of the optical disk 111 to record or reproduce data. That is, a laser light modulated based on encoded data to be recorded is generated from a semiconductor laser source (not shown) of the optical head 106, and radiated onto the recording surface of the optical disk 111 to record the data. At the time of reproduction, a laser beam, which is a reflected light modulated based on a recording pit of the optical disk 111, is converted to an electrical signal and detected as a reproduction signal by an optical detector (not shown) of the optical head 106.

The optical head 106 is mounted on a sled mechanism (not shown) to move to a predetermined track position radially on the optical disk 111 for recording and reproduction. A control signal for the recording and reproduction is generated in the system control circuit 108. An objective lens (not shown) of the optical head 106 is mounted in an actuator (not shown) to process a laser beam. The objective lens is finely positioned to precisely focus the laser beam onto a predetermined recording track of the optical disk 111 based on a control signal generated in the system control circuit 108.

Next, operation of a signal circuit section is explained. First, record data is provided to an interface controller 102 from the host device 101 at the time of data recording. When an original signal is a video signal of a video image, record data compressed by, e.g., the MPEG (Moving Picture Experts Group) method is provided. The record data is temporarily stored in a buffer memory 103. After reading a predetermined amount of the data from the buffer memory 103, a recording circuit 104 adds an error correcting code to the data, and, for example, modulates the data for encoding based on a probability of occurrence of the code to generate a record signal as a light pulse. This record signal is provided to the optical head 106. Then, the record signal is recorded onto the optical disk 111.

The record data temporarily stored in the buffer memory 103 is also provided to a mass storage memory 110 formed of, e.g., a semiconductor memory. A capacity of the mass storage memory 110 may be the same as or greater than that of, e.g., the optical disk 111. Naturally, a capacity of the mass storage memory 110 may be much greater than that of the buffer memory 103. The mass storage memory 110 may be removable by a user.

Conventionally, for example in a recording and reproduction device for television broadcast signals, an optical disk unit typically uses an HDD as a cache memory. In many cases, this device is used such that broadcasted contents are first recorded in the HDD and then sifted or edited and only the contents to be stored for a long time are dubbed onto an optical disk. In this embodiment, the mass storage memory 110 formed of an SDD is used instead of a HDD as a cache memory. As semiconductor memories become inexpensive recently, SDDs can be mounted without cost problem. As compared to HDDs, SDDs operate fast with lower noise. Additionally, the SDD can be mounted in a space in related optical disk units because of its compactness and low power consumption. Typically, when using the HDD, the host device 101 controls the HDD as a different component from the optical disk unit. In contrast, when using the SSD, as shown in FIG. 1, the host device 101 can control the SSD as a component in the optical disk unit together with the unit. The use of the SDD can also contribute to the simplification of the control system.

On the other hand, at the time of reproduction, a reproduction signal detected by the optical head 106 as an electrical signal is provided to the reproduction circuit 105. An AFE (Analog Front End) circuit 105A in the reproduction circuit 105 processes the reproduction signal is to be essentially treated as an analog signal even in digital recording. The AFE circuit 105A generates a TE (Tracking Error) signal and an FE (Focus Error) signal by arithmetically processing the reproduction signal, and provides the generated signals to the system control circuit 108. The system control circuit 108 generates servo control signals for tracking and for focus based on the provided TE signal and FE signal, and provides the servo control signals to the optical head 106 to control operation of the optical head 106. It is noted that a method of generating TE signals and FE signals is not explained in detail because the method is not a main scope of the present invention.

The AFE circuit 105A equalizes frequency characteristics of the amplitude and phase when the data is recorded and reproduced by using the optical head 106 and optical disk 111 to make a waveform of the reproduction signal approximate an output waveform of the recording circuit 104 as much as possible. Further, the reproduction signal is provided to a DEM (Demodulator) circuit 105B to demodulate the reproduction signal subjected to the encoding modulation in the recording circuit 104. Errors during recording and reproduction are corrected in an ECC (Error Correction Circuit) circuit 105C. This functions when an ECCDET (Detector) circuit 105D detects an error based on the error correcting code added in the recording circuit 104. The reproduction data subjected to necessary error correction in the ECC circuit 105C is temporarily stored in the buffer memory 103. The reproduction data stored in the buffer memory 103 is transmitted to the host device 101 sequentially via the interface controller 102.

An output of the ECCDET circuit 105D is also provided to a verification circuit 108A in the system control circuit 108. The verification is executed to determine whether data once recorded has a quality with which error correction is possible in the ECC circuit 105C at the time of reproduction by reproducing the data. Some methods for the verification can be considered. The verification herein is executed based on a frequency of errors detected in the ECCDET circuit 105D.

Timing for the verification is explained. Typically, as one case, it can be considered that the host device 101 requests the optical disk unit to execute only verification while not requiring reproduction data from the optical disk 111. Additionally, it can be considered that the host device 101 requests reproduction data and verification from the optical disk 111 simultaneously. Additionally, it can be considered that, at the same time as (immediately after) recording data in response to a command from the host device, the data is reproduced and verified. Conventionally, data of a disk having the after-mentioned disk management function, such as a BD-RE and DVD-RAM, has been often verified at the same time as (immediately thereafter) recording, and data of a disk not having the disk management function, such as a BD-R, has been often verified in response to a Read command from the host device 101. It is noted that this Read command has been often used in common regardless of whether the host device 101 needs reproduction data.

A determination result in the verification circuit 108A is provided to the interface controller 102. The reproduction data is controlled using the result at the time of outputting the reproduction data to the host device 101 as described below in detail.

Next, operation of the optical disk unit in one embodiment of the present invention is explained in more detail.

Unlike data of the mass storage memory 110 such as a semiconductor memory, data recorded onto and reproduced from the optical disk 111 has a high probability of occurrence of errors. Therefore, as described above, the verification is executed for data recorded on the optical disk 111 to determine whether the data has been recorded with a quality with which error correction is possible at the time of reproduction. Once a recording quality is determined to be good by one verify operation, frequent verification is unnecessary.

In view of the above situation, in this embodiment, multiple verify flags are stored in a control memory 107 coupled to (that may be mounted in) the system control circuit 108. Then, each verify flag corresponds to a data management unit on the optical disk 111. That is, the system control circuit 108 can determine whether each data management unit has been verified in reference to the control memory 107. Of course, since the optical disk 111 is removable from the optical disk unit, a recording capacity for verify flags may be set in the control memory 107 in consideration of the assumed number of optical disks. It is noted that, when the buffer memory 103 is directly accessible from the system control circuit 108, the control memory 107 may be disposed in the buffer memory 103.

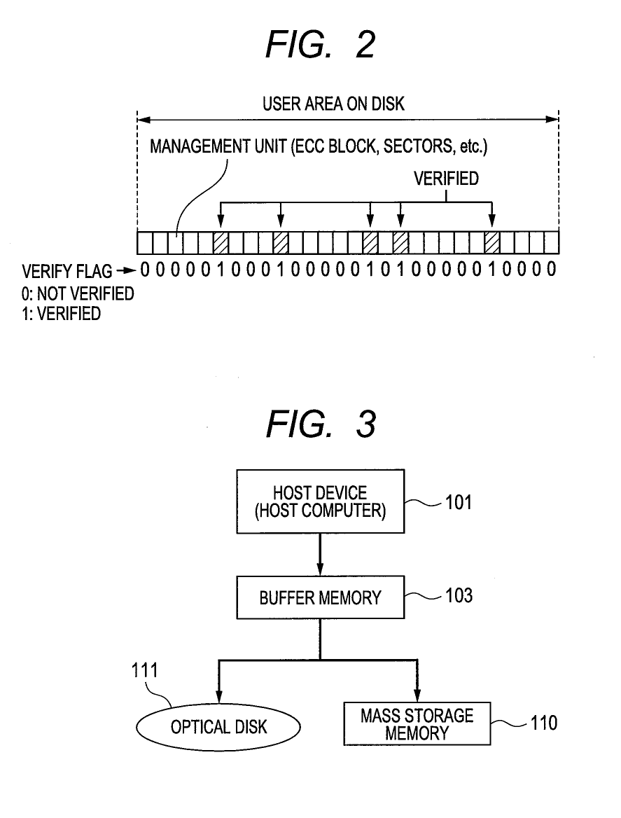

FIG. 2 is a conceptual diagram showing an example of verify flags in one embodiment of the present invention.

Each quadrangle of FIG. 2 shows one management unit. Setting of the management unit is arbitrary. As one example in a DVD, 2,048 bytes are set as one sector, and sixteen sectors are set as a unitary recording area. Recording is made in each recording area to correct errors. This recording area (ECC block) may be used as the management unit. The one sector may be used as the management unit.

FIG. 2 shows arranged multiple management units, showing a user record area spirally arranged from an inner perimeter to outer perimeter of the optical disk 111. When the management units having slashes have been verified and the other units are not yet verified, the former units are each provided with, e.g., a verify flag of 1 and the latter units are each provided with, e.g., a verify flag of 0. Then, the flags are stored in the control memory 107.

It is noted that, when a recording quality is determined to be poor and thus to be a failure after the verification, record data is recovered by the after-mentioned method. When this recovery is successful, the verify flag may be changed from 0 to 1. When the recovery is impossible or fails, an error message etc. is displayed, but the verify flag may remain 0.

Next, the operation of recording and reproduction, including action of the verify flags, is explained again.

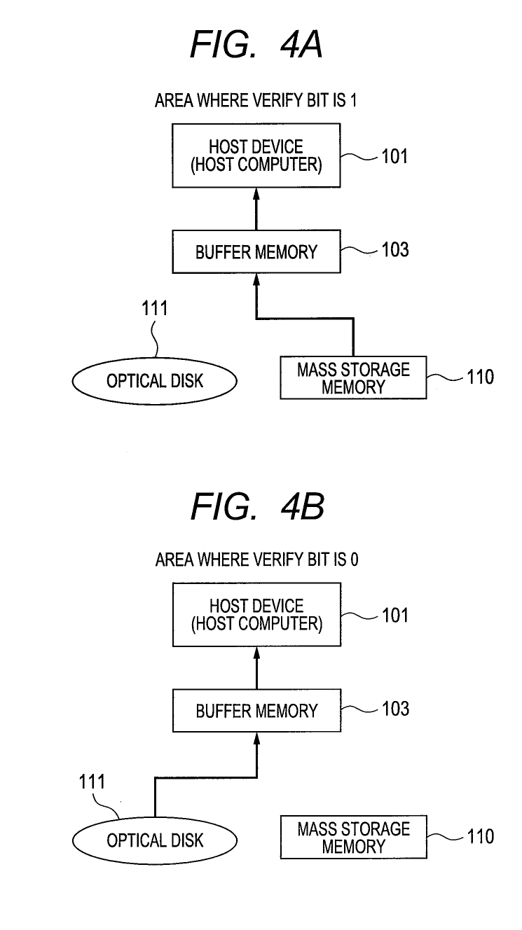

FIG. 3 is a block diagram of the recording circuit in one embodiment of the present invention. FIGS. 4A and 4B are block diagrams of the reproduction circuit in one embodiment of the present invention. These figures are different from the block diagram shown in FIG. 1 in that only the flows of the recording and reproduction are shown, but like references designate identical or similar components.

As shown in FIG. 3, at the time of recording data, record data provided from the host device 101 to the buffer memory 103 is first recorded on both the mass storage memory 110 and optical disk 111.

Next, the reproduction of data is explained. When the system control circuit 108 of FIG. 1 determines that data to be reproduced has been verified (verify flag=1) in the management unit on the optical disk 111 in reference to the verify flags stored in the control memory, the process shown in FIG. 4A is executed. When the system control circuit 108 determines that data to be reproduced is not yet verified (verify flag=0), the process shown in FIG. 4B is executed.

In reference to FIG. 4A, reproduction of verified data on the optical disk 111 is explained. Since the data has been already verified, it is not so important to reproduce and verify the data again. Therefore, the data written in the mass storage memory 110 is read, and sent to the host device 101 via the buffer memory 103. Accordingly, as compared with the case in which the data is reproduced by accessing the optical disk 111, the response time and current consumption can be reduced significantly, and noise of the operation is not generated. This is an advantage achieved using the mass storage memory 110.

On the other hand, as shown in FIG. 4B, when the data is not yet verified on the optical disk 111, the data recorded on the optical disk 111 is reproduced and sent to the host device 101 via the buffer memory 103. In this case, as shown FIG. 1, the verification circuit 108A in the system control circuit 108 determines whether the data has been recorded with a quality with which error correction is possible at the time of reproduction in reference to an error detection signal from the ECCDET (105D).

When the data has been recorded with a quality with which error correction is possible, a corresponding verify flag in the control memory 107 is rewritten, e.g., from 0 to 1, and the data is read from the mass storage memory 110 at the time of the next reproduction. When the data has not been recorded with a quality with which error correction is possible, the data recorded on the optical disk 111 is attempted to be recovered. This is possible on a disk on which a defect on a recording area can be registered and a defect management is possible to register a storage place of recovered data. The disk management is available in BD-REs, BD-Rs, and DVD-RAMs, but unavailable in DVD-Rs. In this case, data to be recovered can be recovered quickly and certainly when the data is provided from the mass storage memory 110 including an SSD. When the data has been recovered, the corresponding verify flag in the control memory 107 is rewritten, e.g., from 0 to 1. Naturally, the recovered data is sent to the host device 101. Therefore, there is an advantage that reliable recovery is possible using the mass storage memory 110 after the verification for the optical disk 111. It is noted that the process when the recovery of the data is failed is explained later.

As is well known, the optical disk 111 is removable and may be mounted in other optical disk units. Therefore, it is desirable to verify data recorded on the optical disk 111 as soon as possible even when a unit personally owned has the mass storage memory 110. Therefore, when data recorded on the optical disk 111 but not yet verified is reproduced such as when data is reproduced at the same time as (immediately after) recording or for the first time, the verification is executed. In this case, the data is reproduced from the optical disk 111 rather than from the mass storage memory 110 and provided to the host device 101.

It is noted that, when a command to execute only the verification is issued from the host device 101, the operation of FIG. 4B may be executed regardless of a verify flag. FIGS. 4A and 4B show the case in which data reproduced from the optical disk 111 is verified and then outputted to the host device 101. In contrast, when a command to execute only the verification is issued from the host device 101 and when data is reproduced by the optical head 106 and verified at the same time as (immediately after) recording the data, the reproduced data may not be outputted to the host device 101.

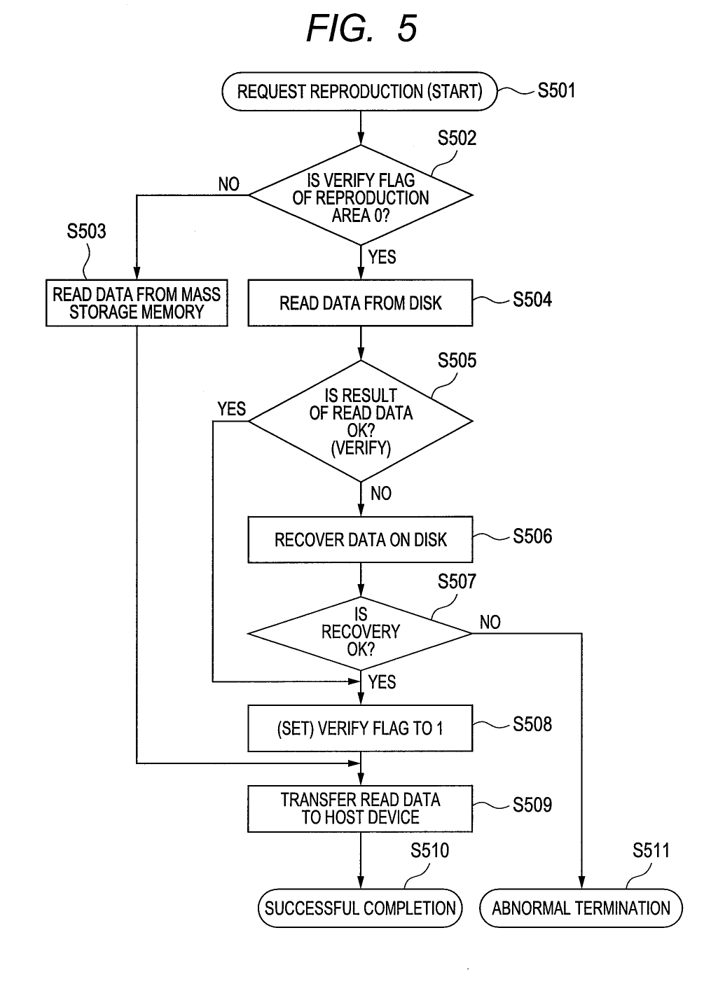

Next, the flow of operation of reproduction is explained. FIG. 5 is a flowchart of a reproduction method in one embodiment of the present invention.

At Step S501, the flow starts when the host device 101 sends a reproduction request of data to the optical disk unit. At Step S502, the system control circuit 108 determines whether a verify flag of a specified area is 0 in reference to verify flags stored in the control memory 107.

When the verify flag is determined not to be 0 (namely determined to be 1, and this is shown as NO in the figure), further verification for the optical disk 111 is unnecessary. Accordingly, at Step S503, the system control circuit 108 reads the data written in the mass storage memory 110. Further at Step S509, the data is transferred to the host device 101. At Step S510, the flow is completed. At Step S510, unlike Step S511 after-mentioned, a successful completion is made because the predetermined operations have been executed.

When the verify flag is determined to be 0 at Step S502 (YES in the figure), the verification for the optical disk 111 is necessary. Accordingly, at step S504 and further steps, the verification is executed. First at Step S504, the data is reproduced from the optical disk 111. At Step S505, the verification circuit 108A of the system control circuit 108 determines whether the data has been recorded with a quality with which error correction is possible at the time of reproduction based on information from the ECCDET (105D). When the data is determined to have been recorded with a quality with which error correction is possible at the time of reproduction, (YES in the figure), the system control circuit 108 sets the verify flag corresponding to the data in the control memory 107 to 1 at Step S508, and further reproduction data (naturally, errors of which has been corrected by the ECC circuit (105C)) is sent to the host device 101 at Step S510. Then, at Step S509, the flow is successfully completed.

When at Step S505 the data is determined not to have been recorded with a quality with which error correction is possible at the time of reproduction (NO in the figure), the data is recovered on the optical disk 111 using, e.g., the above disk management at Step S506. Defect information about an area where the data has been recorded and information about a place where recovered data has been stored are registered onto the optical disk 111. Hereinafter, recovered data is reproduced based on the defect information and storage location information. These pieces of information are often registered onto an innermost periphery and outer periphery of the optical disk 111. Data for recovery is provided from the mass storage memory 110. Next at Step S507, the system control circuit 108 determines whether the data has been recovered. When the data is determined to have been recovered (YES in the figure), the system control circuit 108 rewrites to 1 a verify flag corresponding the data in the control memory 107 at Step S508. Further at Step S509, reproduction data is sent to the host device 101. The flow is successfully completed at Step S510.

When the data is determined not to have been recovered at Step S507, the flow is abnormally terminated at Step S511 because further improvement of data recorded on the optical disk 111 is difficult. In this case, the data provided from the mass storage memory 110 may be sent to the host device 101 as needed. However, the data on the optical disk have not been recovered. Therefore, the system control circuit 108 may control the interface controller 102 to send information showing occurrence of an unrecoverable error to the host device 101 as needed.

It is noted that the case in which the data is determined not to have been recovered at Step S507 may include the case in which a disk not having the disk management function, such as a DVD-R, is used. DVD-Rs are naturally unrecoverable. Even a disk having the disk management, such as a BD-RE, BD-R, and DVD-RAM, cannot be recovered when a recording capacity of the disk is generally full of data and thus the disk has no recordable area, resulting in failure of the recovery.

As described above, in the above embodiment, when the data to be read in response to a command has been verified on the optical disk 111, the data is read from the mass storage memory 110. Accordingly, the response time and electrical current consumption are significantly reduced, and noise is not generated at the time of the operation. When the data is not yet verified, the data is read from the optical disk 111 and verified. The data is certainly recovered using data of the mass storage memory 110 as needed. The control memory 107 has stored the verify flags such that the system control circuit 108 can easily determine whether data has been verified not to repeat unnecessary verification for verified data. By replacing an HDD used conventionally with the mass storage memory 110 formed of an SDD, there is an advantage that downsizing of the recording and reproduction device and simplification of the control system are accomplished.

The embodiments shown so far are one example and do not limit the present invention. Although different embodiments can be considered based on the spirit of the present invention, they are all within the category of the present invention.

While we have shown and described several embodiments in accordance with our invention and it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. An optical disk unit for recording and reproducing information data by use of an optical disk as a first recording medium,
the optical disk unit comprising:
a buffer memory for receiving the information data to be recorded onto the first recording medium and temporarily storing a predetermined amount of the information data, and for storing temporarily and outputting a predetermined amount of reproduced information data;
a second recording medium coupled to the buffer memory to store the information data which has been stored in the buffer memory and is to be recorded on the first recording medium;
a recording circuit for receiving the information data which has been stored in the buffer memory and is to be recorded onto the first recording medium, and for adding, to the information data, an error correcting code for correcting errors occurring during recording and reproduction on the first recording medium;
an optical head for receiving the information data to which the error correcting code has been added in the recording circuit to optically record and reproduce the information data onto and from the first recording medium;
a reproduction circuit for receiving the information data reproduced by the optical head to detect and correct errors occurring in the information data during recording and reproduction on the first recording medium, and for providing, to the buffer memory, the information data after the errors are corrected; and
a system control circuit for controlling operation of the optical disk unit to execute verification for determining whether the information data has been recorded onto the first recording medium with a quality with which error correction is possible in the reproduction circuit at a time of reproduction,
the system control circuit, when reproducing and outputting the information data from the buffer memory, outputting the information data stored in the second recording medium when the information data has been already subject to the verification, and executing the verification for and outputting the information data recorded on the first recording medium when the information data is not yet subject to the verification.

2. The optical disk unit according to claim 1 wherein the second recording medium is a semiconductor memory.

3. The optical disk unit according to claim 1 wherein a recording capacity of the second recording medium is equal to or over a recording capacity of the first recording medium.

4. The optical disk unit according to claim 1 wherein the second recording medium is mounted on a circuit substrate of the optical disk unit.

5. The optical disk unit according to claim 1 wherein the system control circuit has a control memory, and the control memory stores verify flags each showing whether the verification which is set to each record block on the first recording medium has been already executed.

6. A method for reproducing an optical disk unit that records and reproduces information data by use of an optical disk as a first recording medium and a semiconductor memory as a second recording medium, and stores verify flags showing whether the information data recorded on the first recording medium has been already subject to verification for determining whether the information data has been recorded with a quality with which error correction is possible at a time of reproduction,
the method comprising:
determining whether the information data to be reproduced has been already subject to the verification in reference to the verify flags;
first outputting the information data stored in the second recording medium by reading the information data when determining that the information data has been already subject to the verification from a result of determination of the determining step in reference to the verify flags;
reproducing the information data stored in the first recording medium when determining that the information data is not yet subject to the verification from a result of determination of the determining step in reference to the verify flags;
verifying the information data reproduced in the reproducing step to determine whether the information data has been recorded with a quality with which error correction is possible at a time of reproduction;
second outputting the information data reproduced in the reproducing step after changing the verify flag to a state showing that the information data has been already subject to the verification when determining that the information data has been recorded with a quality with which error correction is possible at a time of reproduction from a result of determination of the verifying step;
recovering the information data recorded on the first recording medium on the first recording medium when determining that the information data has not been recorded with a quality with which error correction is possible at a time of reproduction from a result of determination of the verifying step;
determining whether recovery in the recovering step has been successful;
third outputting the information data recovered in the recovering step by reproducing the information data after changing the verify flag to a state showing that the information data has been already subject to the verification when determining that the recovery has been successful from a result of determination of the recovery determining step; and
forth outputting an error flag when determining that the recovery has been failed from a result of the recovery determining step.

7. The method according to claim 6 wherein, in the recovering step, the information data recorded on the first recording medium is recovered based on information data stored in the second recording medium.
